(19) United States
(12) Patent Application Publication
(10) Pub. No.: US 2025/0193575 A1
(43) Pub. Date: Jun. 12, 2025

(54) SPEAKER MODULE FOR HEADSET

(71) Applicants: Jiming XU, Guangdong Province (CN); Xixiang LIU, Guangdong Province (CN); Jingtao LAI, Guangdong Province (CN)

(72) Inventors: Jiming XU, Guangdong Province (CN); Xixiang LIU, Guangdong Province (CN); Jingtao LAI, Guangdong Province (CN)

(21) Appl. No.: 18/432,097

(22) Filed: Feb. 5, 2024

(30) Foreign Application Priority Data
Dec. 7, 2023 (CN) 2023116734201

(51) Int. Cl. H04R 1/10; H04R 1/40

(52) U.S. Cl. CPC H04R 1/1075; H04R 1/1008; H04R 1/1033; H04R 1/1041; H04R 1/406

(57) ABSTRACT

A speaker module for a headset, including a speaker housing; a speaker body, a first microphone, a second microphone, and a circuit board integrated as one module is disposed inside the speaker housing. Accordingly, the speaker module can be directly connected with another component of the headset through a circuit board plug port to complete installation, thereby facilitating the operations of disassembling, checking, and replacing of components. Also, audio and noise reduction debugging of the speaker module can be independently carried out during production without the need to first assemble the entire headset. The speaker module is ready to use once it is manufactured, and the sound effects thereof will not be influenced by other components of the headset.

### BACKGROUND OF THE INVENTION

The present invention relates to the technical field of headsets, and in particular to a speaker module for a headset.

A headset is a conversion unit that receives electrical signals from media players or receivers, and then converts the signals into audible sound waves by utilizing headset speakers adjacent to the ears. Headset can be classified into different types according to how it is worn, for example, an ear-hook type, an in-ear type, an overhead type, and the like. An overhead headset generally comprises a band worn over the top of a head; two cases are connected to two sides of the band respectively, and the two cases correspond to two ears on two sides of the head respectively. Speakers are mounted in the cases respectively, and earmuffs are provided on the cases respectively. The earmuffs are made of soft materials, such that the contact between the cases and the head is more comfortable. In the existing headsets, connections between the cases and the speakers with their electronic components are complex, which requires professional maintenance services consuming a long time to disassemble, check, and replace components if the headset is damaged. In consideration of costs, the headset is often discarded as a whole. In addition, the entire headset needs to be assembled prior to noise reduction debugging or other debugging procedures.

### BRIEF SUMMARY OF THE INVENTION

In view of the foregoing, the present invention provides a speaker module for a headset that solves, at least partially, the problems in the existing headsets where connection between cases and the speakers with their electronic components are complex, and where maintenance and debugging are inconvenient.

The present invention adopts the following technical solutions:

A speaker module for a headset, comprising a speaker housing; a speaker body, a first microphone, a second microphone, and a circuit board are mounted on the speaker housing; the first microphone and the second microphone are oriented in different directions on the speaker housing; the circuit board is electrically connected to the speaker body, the first microphone, and the second microphone; the circuit board is provided with a circuit board plug port adapted to achieve electrical connection with another component of the headset, and the circuit board plug port is exposed from the speaker housing.

Further, the speaker housing comprises a housing body and a housing cover; the speaker body is disposed between the housing body and the housing cover; the first microphone is disposed on the housing cover, and the second microphone and the circuit board are disposed on a back side of the housing body opposite to the housing cover.

Further, a first mounting positioning groove is provided on the back side of the housing body; a wire passing hole is disposed in the first mounting positioning groove; the circuit board is embedded in the first mounting positioning groove, and the circuit board covers the wire passing hole; the first microphone and the speaker body are wired through the wire passing hole so as to be electrically connected with the circuit board.

Further, an annular enclosing plate is provided on an inner side of the housing cover facing towards the housing body; the speaker body is mounted in a space enclosed by the annular enclosing plate; an outer side of the speaker body is hermetically connected to an inner side of the annular enclosing plate;
the housing cover is provided with at least one sound transmission hole located within an area enclosed by the annular enclosing plate;
a sealing gasket surrounding the annular enclosing plate is provided on the inner side of the housing cover; edges of the housing body are pressed against the sealing gasket.

Further, a second mounting positioning groove is provided on the inner side of the housing cover; the second mounting positioning groove is located within the area enclosed by the annular enclosing plate; the first microphone is embedded in the second mounting positioning groove; a third mounting positioning groove is provided on the back side of the housing body, and the second microphone is embedded in the third mounting positioning groove.

Further, a housing body plug port is disposed on the housing body; the housing body plug port is connected with the audio cable; the housing body plug port is electrically connected to the circuit board.

Further, an air hole is disposed on the housing body; and an air permeable membrane is provided on the air hole.

Further, the speaker module comprises a pressing plate disposed outside the speaker housing.

Further, the pressing plate is defined by peripheral portions of the housing cover outside a coverage area by the housing body.

Further, an ethyl vinyl acetate (EVA) cushion is disposed on an outer side of the pressing plate.

As compared with the prior art, the speaker module for a headset according to the present invention integrates the speaker body, the circuit board, the first microphone, and the second microphone into a module, such that the speaker module can be directly connected with another component of the headset through the circuit board plug port to complete installation, thereby facilitating the operations of disassembling, checking, and replacing of components. In addition, audio and noise reduction debugging of the speaker module can be independently carried out during production without the need to first assemble the entire headset. The speaker module is ready to use once it is manufactured, and the sound effects thereof will not be influenced by other components of the headset.

Benefits of other optional features of the present invention will be further described/embodied in the specific embodiments.

### BRIEF DESCRIPTION OF THE DRAWINGS

FIG. 1 is a schematic view of a modular headset according to the present invention;

FIG. 2 is an exploded view of a modular headset according to the present invention;

FIG. 3 is a back view of two speaker modules;

FIG. 4 is a schematic view of a case and a data cable module;

FIG. 5 is a schematic view illustrating the data cable module being fitted on the case;

FIG. 6 is an exploded view of a case, a speaker module, and an earmuff module;

FIG. 7 is a sectional view showing fitting of the speaker module into the case, and also a sectional view of the earmuff module;

FIG. 8 is an exploded view of the speaker module;

FIG. 9 is an exploded view showing a circuit board, a speaker body, and a second microphone exploded from a speaker housing;

FIG. 10 is a schematic view of a headband module;

FIG. 11 is a schematic view of a headband support;

FIG. 12 is an exploded view of an arc-shaped headband, an arc-shaped shell, and one guide plate;

FIG. 13 is a schematic view showing an interior of a connecting handle;

FIG. 14 is an exploded view of the arc-shaped headband, a guide plate, and an elastic positioning member;

FIG. 15 is a longitudinal sectional view of the arc-shaped headband being inserted in a connecting handle; and

FIG. 16 is a cross sectional view of the arc-shaped headband being inserted in the connecting handle.

In the drawings: 1: headband module; 11: headband support; 111: arc-shaped headband; 1111: inserting hole; 1112: through opening; 112: connecting handle; 1121: inserting channel; 1122: limiting guide portion; 1123: limiting groove; 1124: first limiting rib; 1125: second limiting rib; 113: case mounting bracket; 1131: connecting arm; 1132: hinge portion; 1133: rotating end; 1134: third wire passage; 114: arc-shaped shell; 115: guide plate; 1151: second wire passage; 1152: holding plate; 116: clamping assembly; 1161: upper cover; 1162: lower cover; 117: elastic positioning member; 1171: clamping portion; 1172: protruding portion; 12: case; 121: mounting cavity; 122: wiring module; 1221: wiring module plug port; 1222: wiring board; 123: connecting wire; 124: wire passing groove; 125: supporting portion; 126: positioning hole; 127: buckling piece; 128: mounting groove;
2: speaker module; 21: speaker housing; 211: housing body; 2111: first mounting positioning groove; 2112: wire passing hole; 2113: third mounting positioning groove; 2114: air hole; 212: housing cover; 2121: second mounting positioning groove; 2122: sealing gasket; 2123: pressing plate; 2124: clearance groove; 2125: positioning post; 2126: annular enclosing plate; 2127: sound transmission hole; 213: EVA cushion; 22: circuit board; 221: circuit board plug port; 222: housing body plug port; 23: speaker body; 24: first microphone; 25: second microphone; 26: air permeable membrane;
3: earmuff module; 31: lid; 32: soft earmuff;
4: data cable module; 41: data cable body; 42: data cable plug port; 43: anti-pulling portion; and 44: baffle portion.

### DETAILED DESCRIPTION OF THE INVENTION

The technical solutions in embodiments of the present invention will be described clearly and thoroughly below, and it is apparent that the described embodiments are only some but not all of the embodiments of the present invention. On the basis of the embodiments of the present invention, all other embodiments obtainable by those of ordinary skills in the art without any inventive efforts shall also fall within the protection scope of the present invention.

In the present invention, unless otherwise explicitly specified and limited, terms such as “mount”, “connect”, “link”, “fix” and the like should be interpreted in a broad sense. For example, it may be a fixed connection, a detachable connection or integration; may be a mechanical connection or an electric connection; or may be a direct connection, an indirect connection by means of an intermediate, an internal interconnection of two elements or an interaction of two elements. For those of ordinary skill in the art, the specific meanings of the above terms in the present invention can be understood according to specific situations.

In addition, the terms “first” and “second” are only for the purpose of description, and may not be construed as indicating or implying the relative importance or implicitly indicating the number of technical features indicated. Thus, features defined by “first” and “second” may explicitly or implicitly include one or more of that feature. In the description of the present invention, “plurality” refers to two or more, unless otherwise explicitly and specifically defined.

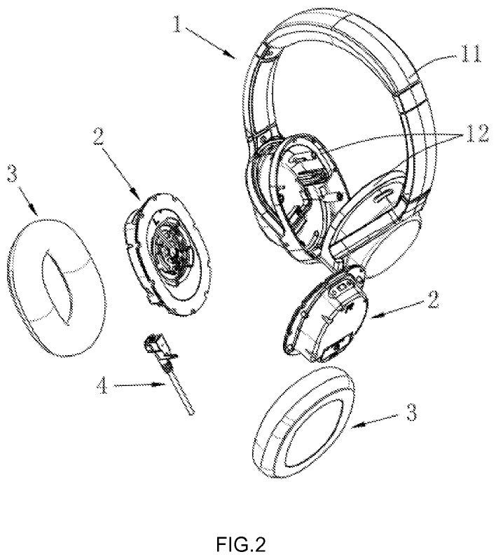

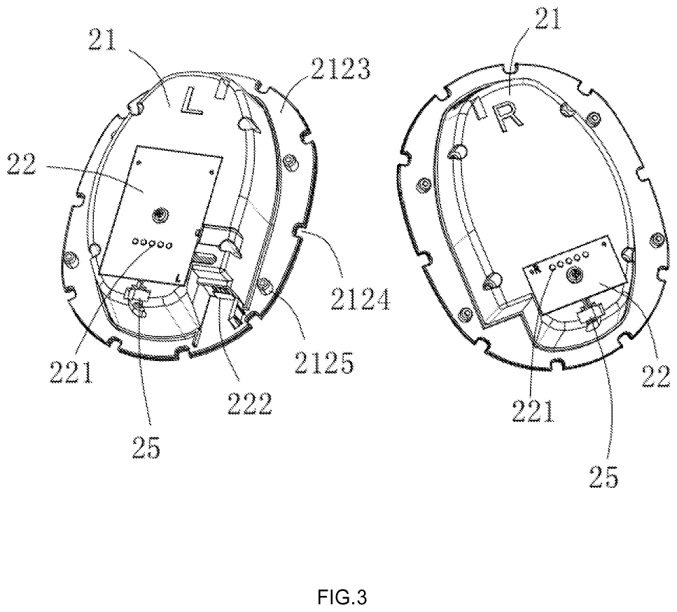

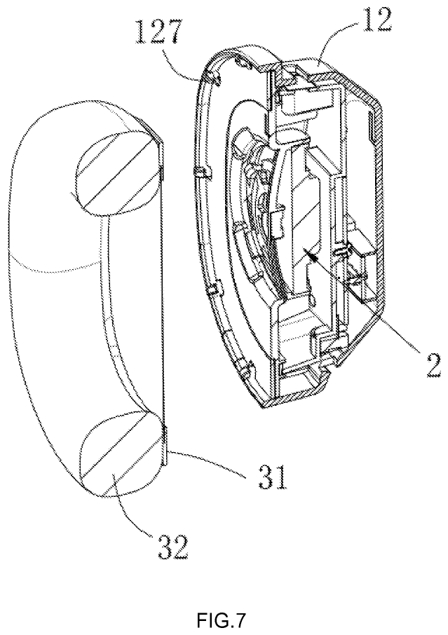

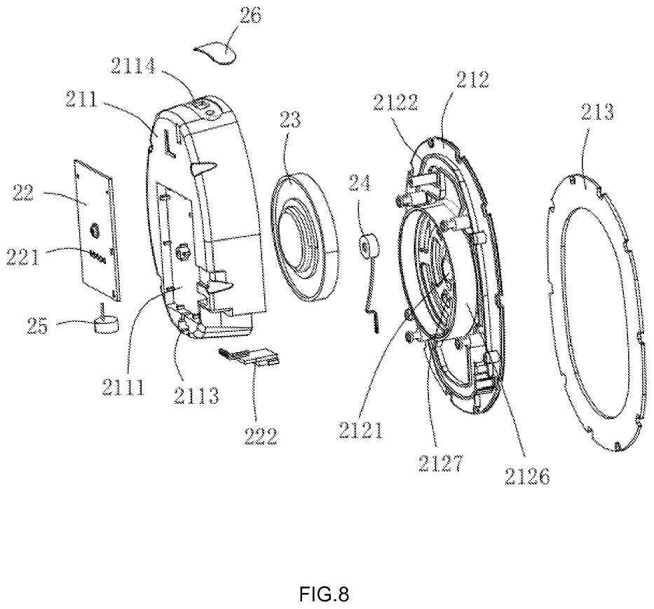

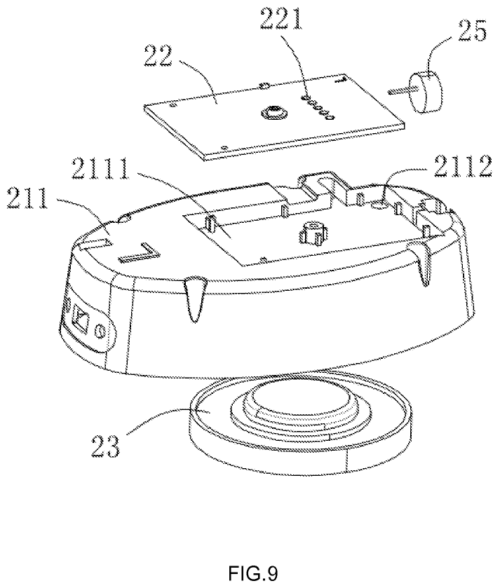

Referring to FIG. 2, FIG. 3, FIG. 7, FIG. 8, and FIG. 9, a speaker module for a headset is shown, comprising a speaker housing 21; a speaker body 23, a first microphone 24, a second microphone 25, and a circuit board 22 are mounted on the speaker housing 21. The first microphone 24 and the second microphone 25 are oriented in different directions on the speaker housing 21. The circuit board 22 is electrically connected to the speaker body 23, the first microphone 24, and the second microphone 25. The circuit board 22 is provided with a circuit board plug port 221 adapted to achieve electrical connection with another component of the headset, and the circuit board plug port 221 is exposed from the speaker housing 21.

The first microphone 24 and the second microphone 25 collect environmental noises from different directions, and then noise reduction debugging can be carried out. Circuit structures associated with achieving relevant functions of the headset are integrated on the circuit board 22. The embodiment described herein does not involve improvements of these circuit structures, so these circuit structures are prior arts and therefore will not be described in detail herein. In addition, during actual use, one headset should be provided with two speaker modules 2, which correspond to a left ear and a right ear respectively. Among the two speaker modules 2, the circuit structures for achieving relevant functions of the headset can be integrated on the circuit board 22 of one of the two speaker modules 2 only, or can be distributed to the circuit boards 22 of both speaker modules 2. Details of disposing the speaker modules 2 on the headset will be described later.

Compared to the prior art, the speaker module 2 for a headset according to the present invention integrates the speaker body 23, the circuit board 22, the first microphone 24, and the second microphone 25 into a module, such that the speaker module 2 can be directly connected with another component of the headset through the circuit board plug port 221 to complete installation, thereby facilitating the operations of disassembling, checking, and replacing of components. In addition, audio and noise reduction debugging of the speaker module can be independently carried out during production without the need to first assemble the entire headset. The speaker module is ready to use once it is manufactured, and the sound effects thereof will not be influenced by other components of the headset. Specifically, if a conventional headset is sent to a maintenance station for maintenance in case of damage, even though damaged components can be replaced, sound effects of the headset cannot be debugged due to the lack of debugging equipment in the maintenance station. However, according to the present embodiment, since the speaker module 2 has already been debugged before leaving the factory, so the maintenance station can directly replace the damaged components without the need for further debugging procedures.

Specifically referring to FIG. 8, for convenience of mounting, the speaker housing 21 comprises a housing body 211 and a housing cover 212; the speaker body 23 is disposed between the housing body 211 and the housing cover 212; the first microphone 24 is disposed on the housing cover 212, and the second microphone 25 and the circuit board 22 are disposed on a back side of the housing body 211 opposite to the housing cover; the housing body 211 may be screwed with the housing cover 212, and the speaker housing 21 can protect the speaker body 23.

Specifically referring to FIG. 8 and FIG. 9, to facilitate the speaker body 23 and the first microphone 24 to be electrically connected to the circuit board 22, a first mounting positioning groove 2111 is provided on the back side of the housing body 211; a wire passing hole 2112 is disposed in the first mounting positioning groove 2111; the circuit board 22 is embedded in the first mounting positioning groove 2111, and the circuit board 22 covers the wire passing hole 2112. The first microphone 24 and the speaker body 23 are wired through the wire passing hole 2112 so as to be electrically connected with the circuit board 22. The first mounting positioning groove 2111 stabilizes a mounting position of the circuit board 22, so as to ensure stable docking of the circuit board plug port 221 during subsequent connection of the circuit board plug port 221.

Specifically referring to FIG. 8, an annular enclosing plate 2126 is provided on an inner side of the housing cover 212 facing towards the housing body; the speaker body 23 is mounted in a space enclosed by the annular enclosing plate 2126; an outer side of the speaker body 23 is hermetically connected to an inner side of the annular enclosing plate 2126, for example, by using glue. The housing cover 212 is provided with at least one sound transmission hole 2127 located within an area enclosed by the annular enclosing plate 2126, and the sound transmission hole 2127 allows sounds from the speaker body 23 to be transmitted to the user. A sealing gasket 2122 surrounding the annular enclosing plate 2126 is provided on the inner side of the housing cover 212; edges of the housing body 211 are pressed against the sealing gasket 2122. An air hole 2114 is disposed on the housing body 211, and an air permeable membrane 26 is provided on the air hole 2114. Air discharge can be adjusted by configuring air permeable membranes 26 of different specifications, so that audio effects of high, middle, and low tones of the speaker body can be adjusted.

Specifically referring to FIG. 8, for ensuring stable mounting of the first microphone 24 and the second microphone 25, a second mounting positioning groove 2121 is provided on the inner side of the housing cover 212, and the first microphone 24 is embedded in the second mounting positioning groove 2121; a third mounting positioning groove 2113 is provided on the back side of the housing body 211, and the second microphone 25 is embedded in the third mounting positioning groove 2113. Accordingly, the first microphone 24 and the second microphone 25 are prevented from shaking and vibrating, thus ensuring stable performance of receiving sounds.

Specifically referring to FIG. 3 and FIG. 8, if the headset is wired (as opposite to wireless), an audio cable needs to be connected, a housing body plug port 222 is disposed on the housing body 211 for connection with the audio cable; the housing body plug port 222 is electrically connected to the circuit board 22. Generally, in a headset having two speaker modules 2, it is only required to have the audio cable connecting to only one of the speaker modules 2, and such connection will be detailed later.

A modular headset employing the speaker module 2 of the present invention will be described below to highlight the utility and advantages of the speaker module 2 of the present invention, as well as to facilitate the illustration of other optional embodiments of the speaker module 2.

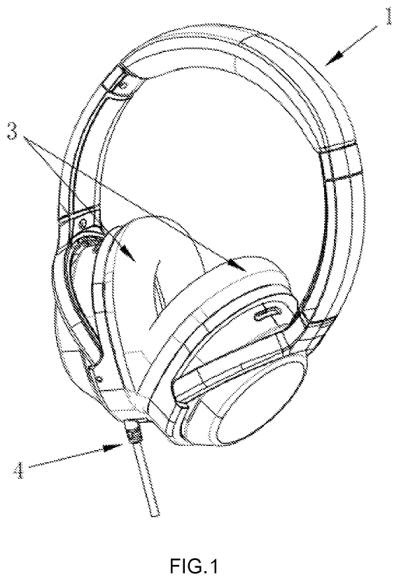

Referring to FIG. 1 and FIG. 2, a modular headset is shown, comprising a headband module 1, speaker modules 2, and earmuff modules 3.

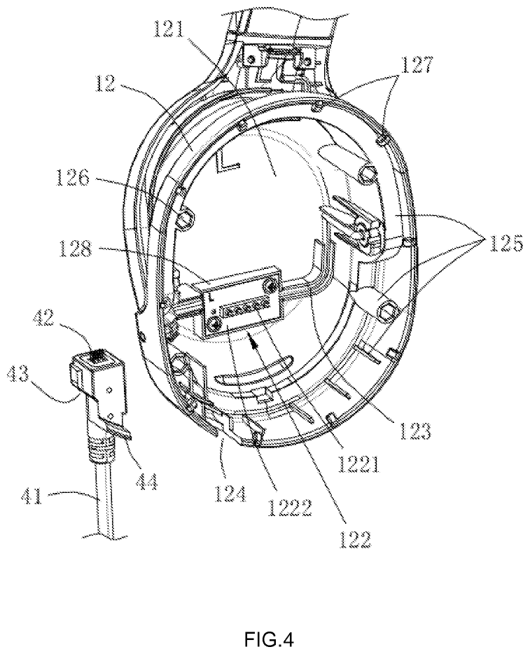

Referring to FIG. 2 and FIG. 4, the headband module 1 comprises a headband support 11 configured to be worn over the top of a head of a human body. Two cases 12 are disposed on the headband support 11; each case 12 has a mounting cavity 121; a wiring module 122 is disposed in each mounting cavity 121; a wiring module plug port 1221 is provided on each wiring module 122; wiring modules 122 of two mounting cavities 121 are electrically connected to each other through a connecting wire 123.

Referring to FIG. 3, each of the speaker modules 2 is embedded in a corresponding mounting cavity 121, and each of the speaker modules 2 comprises a speaker housing 21. The speaker housing 21 is provided with a speaker body 23 and a circuit board 22, and the circuit board 22 is provided with a circuit board plug port 221. The circuit board 22 is electrically connected to the speaker body 23 and the circuit board plug port 221. Circuit structures for achieving relevant functions of the headset are integrated on the circuit board 22 of one of the speaker modules 2.

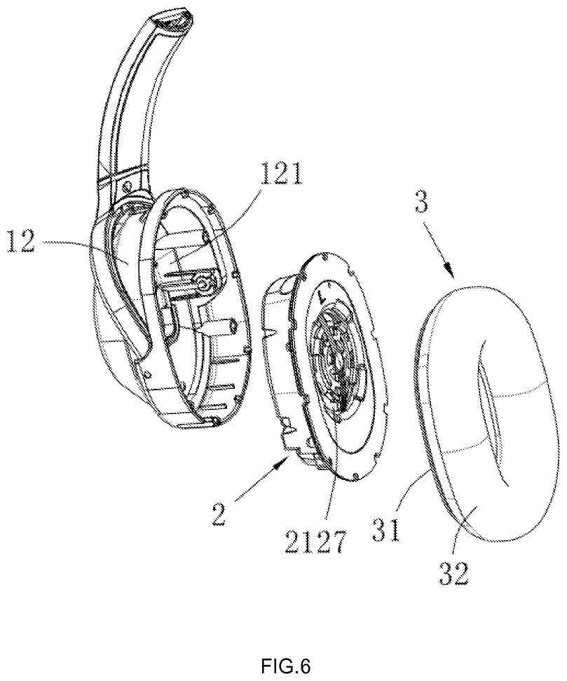

Referring to FIG. 6, each of the earmuff modules 3 comprises a lid 31 and a soft earmuff 32 disposed on the lid 31.

Specifically referring to FIG. 2, FIG. 6, and FIG. 7, the headband module 1, the speaker modules 2, and the earmuff modules 3 are independent from one another. Each of the speaker modules 2 is embedded in the corresponding mounting cavity 121; the circuit board plug port 221 of each of the speaker modules 2 is connected to a corresponding wiring module plug port 1221 of a corresponding case 12. Accordingly, the two speaker modules 2 are electrically connected to each other. The lid 31 of a corresponding earmuff module 3 is buckled to the corresponding case 12, such that a corresponding speaker module 2 is pressed in the mounting cavity 121 of the corresponding case 12 by using the lid 31, thus preventing the corresponding speaker module 2 from being detached from the mounting cavity 121.

According to the present embodiment, in each of the speaker modules 2, the circuit board 22 and the speaker housing 21 are first being integrated, and then the circuit board plug port 221 is additionally configured to form a corresponding speaker module 2. Meanwhile, the wiring module plug port 1221 is disposed in a corresponding case 12, such that the corresponding speaker module 2 can be electrically connected to the corresponding case 12 by insertion. Therefore, professional knowledge is not required to install or replace a speaker module 2; the speaker module 2 can be installed or replaced without additional use of tools or additional operations like soldering. In addition, each of the speaker modules 2 is fixed by using the lid 31 of a corresponding earmuff module 3, and as the lid 31 is buckled to the corresponding case 12, the lid 31 can be directly removed from the corresponding case 12 without using tools, such that the speaker module 2 can be quickly installed and uninstalled. In the present embodiment, the headband module 1, each of the speaker modules 2, and each of the earmuff modules 3 can be independently replaced in case of damage, so the service life of the entire headset is prolonged. Since professional knowledge is not required to replace the modules, professional requirements for maintenance workers are lowered, and hence the costs for human resources are reduced, and users can even carry out the maintenance by themselves. Accordingly, the difficulties and costs of after-sales maintenance are reduced.

Preferably, referring to FIG. 3 and FIG. 4, to facilitate stable clamping of the speaker modules 2, each of the speaker modules 2 comprises a pressing plate 2123 disposed outside the speaker housing 21; correspondingly, supporting portions 125 are disposed in the mounting cavity 121 of a corresponding case 12; the pressing plate 2123 is clamped between the supporting portions 125 and the lid 31 of a corresponding earmuff module 3. The supporting portions 125 may be columnar structures disposed in the mounting cavity 121, reinforcing ribs disposed on inner walls of the mounting cavity 121, or stepped platforms formed in the mounting cavity 121, as long as they can stably support the pressing plate 2123. The pressing plate 2123 is clamped by the supporting portions 125 of the corresponding case 12 and the lid 31 of the corresponding earmuff module 3 to achieve stable fixation of the corresponding speaker module 2.

In practical application, as shown in FIG. 8, the pressing plate 2123 is defined by peripheral portions of the housing cover 212 outside a coverage area by the housing body 211. In addition, an ethyl vinyl acetate (EVA) cushion 213 is disposed on an outer side of the pressing plate 2123. The EVA cushion 213 enables hermetical abutment of the pressing plate 2123 against the lid 31 of the corresponding earmuff module 3, thereby preventing external noises from slipping in through a gap between the pressing plate 2123 and the lid 31, thus achieving a better audio playing effect.

Preferably, referring to FIG. 3 and FIG. 4, a positioning mechanism is further provided. The positioning mechanism comprises positioning posts 2125 and positioning holes 126 into which the positioning posts 2125 are inserted. The positioning posts 2125 are disposed on the pressing plate 2123 of each of the speaker modules 2, and the positioning holes 126 are disposed in the mounting cavity 121 of each of the cases 12. Through positioning by insertion of the positioning posts 2125 into the positioning holes 126, the wiring module plug port 1221 of each case 12 and the circuit board plug port 221 of a corresponding speaker module 2 can be interfaced accurately with each other after the speaker module 2 is placed in the mounting cavity 121 of the case 12. When the supporting portions 125 of each case 12 and the lid 31 of a corresponding earmuff module 3 clamp the pressing plate 2123 of a corresponding speaker module 2, the speaker module 2 is prevented by friction from being laterally displaced. In the present embodiment, by also providing the positioning posts 2125 and the positioning holes 126, where the positioning posts 2125 functions to resist lateral shearing force, the speaker module 2 will not be laterally displaced with respect to the corresponding case 2 even when the headset is swung by a great external force, thereby ensuring still a stable electrical connection between the wiring module plug port 1221 of the corresponding case 2 and the circuit board plug port 221 of the speaker module 2.

It should be noted that, as shown in FIG. 3 and FIG. 4, the positioning holes 126 are disposed in the mounting cavity 121 of each of the cases 12, and the positioning posts 2125 are disposed on the pressing plate 2123 of each of the speaking modules 2. However, in practice, the positioning holes 126 may be disposed on the pressing plate 2123 of each of the speaking modules 2, and the positioning posts 2125 may be disposed in the mounting cavity 121 of each of the cases 12, given that such alternative configurations will not be in conflict with other structures of the present invention.

Preferably, referring to FIG. 4, FIG. 6, and FIG. 7, to facilitate buckle connection between the lid 31 of each of the earmuff module 3 and a corresponding case 12, a plurality of buckling pieces 127 are provided on the inner walls of the mounting cavity 121 of the case 12. The lid 31 is a plate, and therefore the buckling pieces 127 are buckled to outer edges of the lid 31. In this way, when the case 12 is buckled to the lid 31, the plurality of buckling pieces 127 clutch the outer edges of the lid 31. When the buckling pieces 127 clutch the outer edges of the lid 31, the buckling pieces 127 are positioned in a gap between the lid 31 and the soft earmuff 32, so that the soft earmuff 32 conceals the buckling pieces 127, preventing the buckling pieces 127 from being exposed which may otherwise affecting the aesthetic appearance of the headset. In order to avoid interference of the pressing plate 2123 of the corresponding speaker module 2 with the buckling pieces 127, clearance grooves 2124 corresponding to the buckling pieces 127 are provided around outer edges of the pressing plate 2123.

Preferably, referring to FIG. 4, the wiring module 122 of each of the cases 12 comprises a wiring board 1222 on which the wiring module plug port 1221 is disposed; the wiring board 1222 can be a PCB board. A mounting groove 128 is provided in the mounting cavity 121 of each of the cases 12, a corresponding wiring board 1222 is embedded in each mounting groove 128, and the wiring board 1222 embedded in each mounting groove 128 can be screwed and fixed with the mounting groove 128. In this way, by positioning the wiring board 1222 through the mounting groove 128, the wiring module 122 is prevented from being displaced in the mounting cavity 121, thereby preventing connection between the wiring module plug port 1221 of each case 12 and the circuit board plug port 221 of a corresponding speaker module 2 from becoming loosened.

In addition, the headset may be wired, or may be wireless.

In some embodiments as shown in FIG. 2 and FIG. 4, the modular headset of the present invention further comprises a data cable module 4. The data cable module 4 comprises a data cable body 41 and a data cable plug port 42 disposed on the data cable body 41. The data cable body 41 is, for example, an audio cable. Referring to FIG. 3, a housing body plug port 222 is disposed on one of the speaker modules 2 in which the circuit structures for achieving the functions of the headset are integrated on the circuit board 22 of the speaker module 2. The housing body plug port 222 is electrically connected to the circuit board 22, and the housing body plug port 222 is interfaced with the data cable plug port 42 to achieve electrical connection between the circuit board 22 and the data cable module 4.

Specifically, as shown in FIG. 2, in the present embodiment, one headband module 1, two speaker modules 2, two earmuff modules 3, and one data cable module 4 are provided. During assembly, the data cable module 4 is first connected to one of the speaker modules 2 provided with the housing body plug port 222, then the two speaker modules 2 are embedded into corresponding cases 12, and finally the earmuff modules 3 are assembled. The data cable module 4 is plugged into said one of the speaker modules 2, and therefore the assembly and disassembly can be completed through simple plug-in and plug-off operations.

Preferably, referring to FIG. 4, a wire passing groove 124 is formed on a side wall of the mounting cavity 121 of one of the cases 12 corresponding to the data cable module 4, and the data cable body 41 passes through the wire passing groove 124. The data cable body 41 is provided with an anti-pulling portion 43 having a width larger than that of the wire passing groove 124, and the anti-pulling portion 43 abuts against an inner side of the mounting cavity 121. The anti-pulling portion 43 may have any shape as long as the anti-pulling portion 43 has the width larger than that of the wire passing groove 124 so that the anti-pulling portion 43 will not drop off from the wire passing groove 124. With the limiting function of the anti-pulling portion 43, the data cable module 4 can be prevented from being pulled out unless when a corresponding earmuff module 3 is detached, thereby preventing connection between the data cable module 4 and said one of the speaker module 2 from becoming loosened.

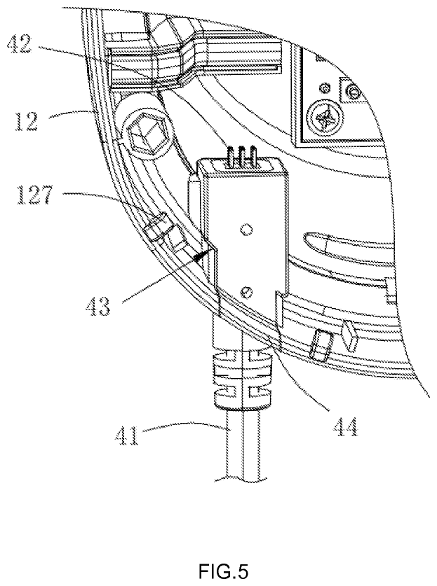

Preferably, referring to FIG. 5, the data cable body 41 is provided with a baffle portion 44. The baffle portion 44 fits into the wire passing groove 124; an outer wall profile of the baffle portion 44 flushes with an outer wall profile of one of the cases 12. In this way, the baffle portion 44 can close the wire passing groove 124, thereby enhancing the aesthetic appearance and preventing foreign matters from entering to said one of the cases 12 through the wire passing groove 124.

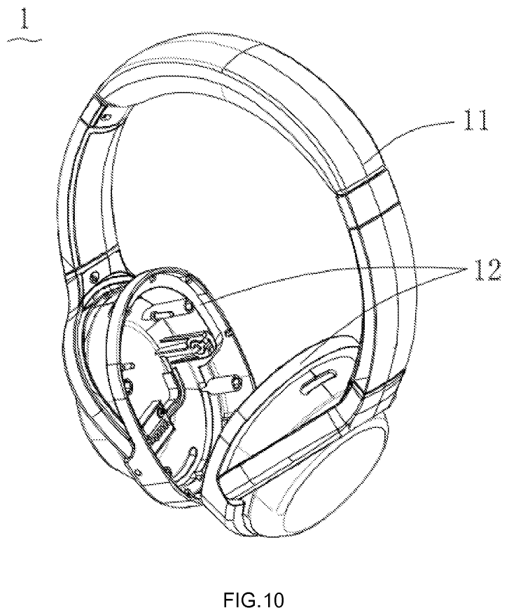

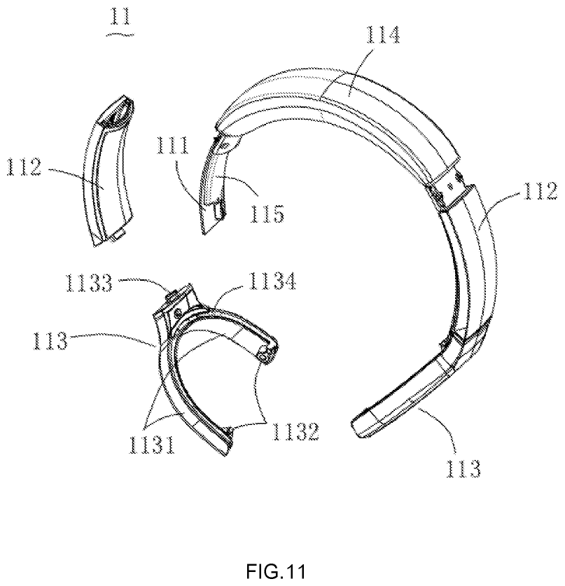

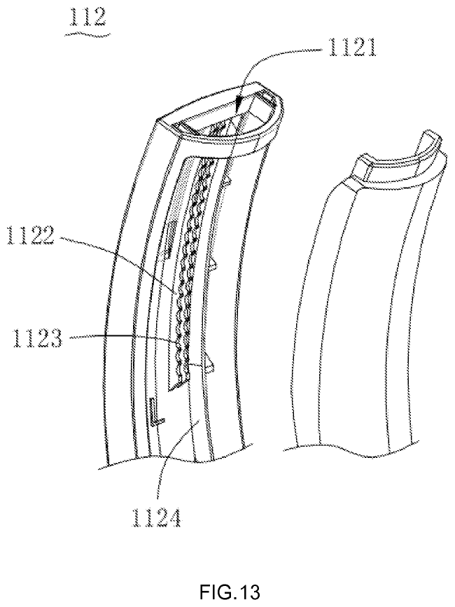

In some embodiments, referring to FIG. 10, the headband module 1 comprises the headband support 11 and the cases 12. Referring to FIG. 11 to FIG. 16, the headband support 11 comprises an arc-shaped headband 111, connecting handles 112, and case mounting brackets 113. The arc-shaped headband 111 is provided with removably mounted elastic positioning members 117. Two ends of the arc-shaped headband 111 are connected to the connecting handles 112 respectively. An inserting channel 1121 into which the arc-shaped headband 111 is inserted is provided at one end of each of the connecting handles 112. A limiting guide portion 1122 is disposed in each inserting channel 1121. A plurality of limiting grooves 1123 which are selectively abutted by a corresponding elastic positioning member 117 are provided on the limiting guide portion 1122, and the limiting grooves 1123 are arranged along a lengthwise direction of the corresponding connecting handle 112. Another end of each of the connecting handles 112 is rotatably connected to a corresponding case mounting bracket 113. Each of the case mounting brackets 113 comprises two connecting arms 1131. Hinge portions 1132, which are rotatably connected to a corresponding case 12, are provided at inner sides of the connecting arms 1131 respectively.

Specifically, the arc-shaped headband 111 is made of an elastic material, and is capable of biasing the two connecting handles 112 to approach towards each other, thereby enabling the headband to be worn over the top of the head of the human body. The two ends of the arc-shaped headband 111 are connected to the connecting handles 112 respectively in a telescopic manner, such that the headband can adapt to heads of different sizes. As shown in FIG. 11, each case mounting bracket 113 is substantially Y-shaped, and each case mounting bracket 113 can rotate on a corresponding connecting handle 112, such that a corresponding case 12 can be turned left and right. Each case 12 is hinged between the two connecting arms 1131 of a corresponding case mounting bracket 113, such that the corresponding case 12 can be turned up and down. Therefore, positions and orientations of both cases 12 can be adjusted according to orientations of the ears, such that the headband support 11 can be adjusted according to different head shapes, thereby improving wearing comfort. Also, the elastic positioning members 117 are detachable from the arc-shaped headband 111, so that when the elasticity of the elastic positioning member 117 is weakened or vanished, the arc-shaped headband 111 can be pulled out from the inserting channels 1121 to replace the elastic positioning members 117 to ensure stable telescopic adjustments between the arc-shaped headband 111 and the connecting handles 112.

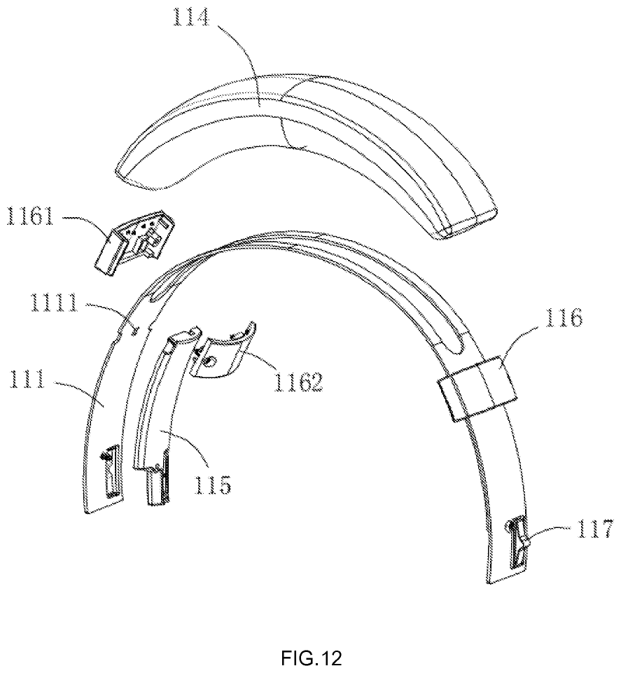

Preferably, referring to FIG. 12, a hollow arc-shaped shell 114 is further provided. A middle part of the arc-shaped headband 111 is sleeved by the arc-shaped shell 114; a first wire passage (not shown in the figures) is formed inside the arc-shaped shell 114. The arc-shaped shell 114 may be made of plastic, and a soft pad layer is provided on an outer side of the arc-shaped shell 114. Alternatively, the arc-shaped shell 114 itself may be made of a soft material, such as sponge, so that the head of the human body can feel more comfortable when wearing the headband module 1.

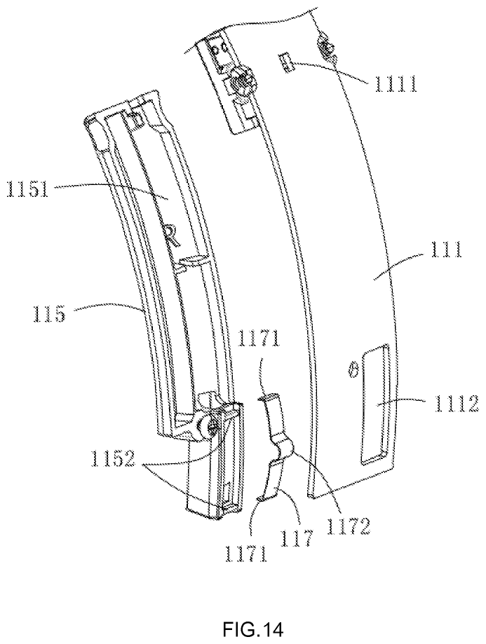

As said, the first wire passage (not shown in the figures) is formed inside the arc-shaped shell 114. Referring again to FIG. 12 and FIG. 14, guide plates 115 are arranged on the arc-shaped headband 111, and each of the guide plates 115 is inserted into the inserting channel 1121 of a corresponding connecting handle 112. A second wire passage 1151 is formed between each of the guide plates 115 and the arc-shaped headband 111. One end of each second wire passage 1151 is communicated with the first wire passage, and another end of each second wire passage 1151 is communicated with the inserting channel 1121 of the corresponding connecting handle 112. A third wire passage 1134 is formed in each of the case mounting brackets 113; an opening of each third wire passage 1134 is located on one of the hinge portions 1132 of a corresponding case mounting bracket 113, so as to achieve an internal communication between each third wire passage 1134 and a corresponding case 12. Each of the case mounting brackets 113 is provided with a rotating end 1133 rotatably connected to a corresponding connecting handle 112, and the rotating end 1133 is rotatably connected to an end portion of the corresponding connecting handle 112 by insertion. Another opening of each third wire passage 1134 is located on the rotating end 1133 of the corresponding case mounting bracket 113, so as to achieve communication between the third wire passage 1134 and the inserting channel 1121 of the corresponding connecting handle 112.

Therefore, the connecting wire 123 is arranged through the third wire passage 1134 of each of the case mounting brackets 113, the inserting channel 1121 of each of the connecting handles 112, the second wire passage 1151 of each of the guide plates 115, and the first wire passage of the arc-shaped shell 114. Each of two ends of the connecting wire 123 pass through said one of the hinge portions 1132 of a corresponding case mounting bracket 113 and enters a corresponding case 12. Therefore, the connecting wire 123 is concealed inside and hence protected by the headband support 11, and the aesthetic appearance of the headset is improved due to concealed connecting wire 123.

Preferably, referring to FIG. 12, two clamping assemblies 116 are fixedly provided on the arc-shaped headband 111. Each of the clamping assemblies 116 comprises an upper cover 1161 and a lower cover 1162; the upper cover 1161 and the lower cover 1162 are clamped at front and back surfaces of the arc-shaped headband 111 respectively. The arc-shaped shell 114 is positioned between the two clamping assemblies 116. The arc-shaped shell 114 is fixed in position on the arc-shaped headband 111 by the two clamping assemblies 116. One end of each of the guide plates 115 is clamped between the arc-shaped headband 111 and a corresponding lower cover 1162, and another end of each of the guide plates 115 is locked to the arc-shaped headband 111 by a bolt fastener, thereby achieving a stable connection of the guide plates 115 to the arc-shaped headband 111.

Referring to FIG. 12, the upper cover 1161 and the lower cover 1162 of each of the clamping assemblies 116 are locked to each other by bolt fasteners. Inserting holes 1111 are provided on the arc-shaped headband 111 corresponding to the two clamping assemblies 116 respectively, and the upper cover 1161 or the lower cover 1162 of each of the clamping assemblies 116 is provided with an insert piece (not shown in the figures) inserted into a corresponding inserting hole 1111. Accordingly, the clamping assemblies 116 are quickly fixed in position, and the stability of connection between the clamping assemblies 116 and the arc-shaped headband 111 is improved.

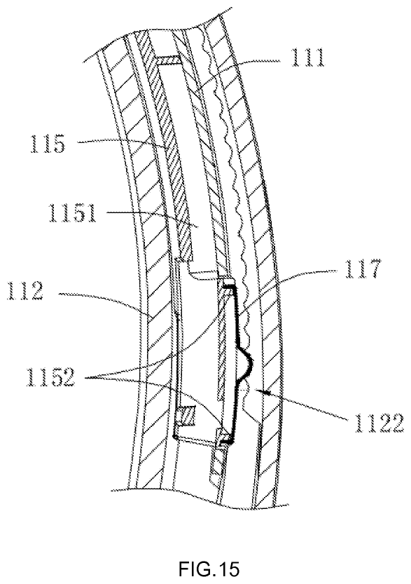

Preferably, referring to FIG. 14 and FIG. 15, each of the elastic positioning members 117 is an elastic sheet; in each elastic sheet, two ends of the elastic sheet are bent towards a same first side to form two clamping portions 1171, and a middle part of the elastic sheet is bent towards a second side opposite to the first side to form a protruding portion 1172 protruding towards the second side. Two holding plates 1152 are provided on each of the guide plates 115, and the two clamping portions 1171 of each elastic sheet clamp at outer sides of the two holding plates 1152 of a corresponding guide plate 115 respectively; the protruding portion 1172 of each elastic sheet abuts against one of the limiting grooves 1123 of a corresponding limiting guide portion 1122. In each of the elastic positioning members 117, the two clamping portions 1171 are biased to press against each other, and by also clamping to the outer sides of the two holding plates 1152 respectively, the elastic positioning member 117 is fixed on the corresponding guide plate 115. When the elastic positioning members 117 require replacement, the elastic positioning members 117 can be directly pulled out from the corresponding guide plates 115 without using any tools. As shown in FIG. 12, the protruding portion 1172 of each of the elastic positioning members 117 abuts against one of the limiting grooves 1123 of the corresponding limiting guide portion 1122, so as to fix a position of a corresponding connecting handle 112 relative to the arc-shaped headband 111. When the arc-shaped headband 111 is pulled, each of the elastic positioning members 117 is pressed, and the two clamping portions 1171 of each of the elastic positioning members 117 are forced to bend away from each other, so that the protruding portion 1172 of each of the elastic positioning members 117 can slide on the limiting guide portion 1122 of the corresponding connecting handle 112. Since the protruding portion 1172 of each of the elastic positioning members 117 still abuts and in contact with the limiting guide portion 1122 of the corresponding connecting handle 112 as the protruding portion 1172 of each of the elastic positioning members 117 slides on the limiting guide portion 1122 of the corresponding connecting handle 112, each of the elastic positioning members 117 will not be disengaged from the corresponding guide plate 115. The elastic positioning members 117 can only be removed when the arc-shaped headband 111 is pulled out from the inserting channels 1121.

It should be noted that a length of the connecting wire 123 is sufficient enough so that the connecting wire 123 will not be tensioned to an extent that it will break when the arc-shaped headband 111 is pulled out from the inserting channels 1121. In addition, referring to FIG. 14, in order to avoid structural interference, the arc-shaped headband 111 is provided with through openings 1112; two holding plates 1152 of each of the guide plates 115 can pass through a corresponding through opening 1112.

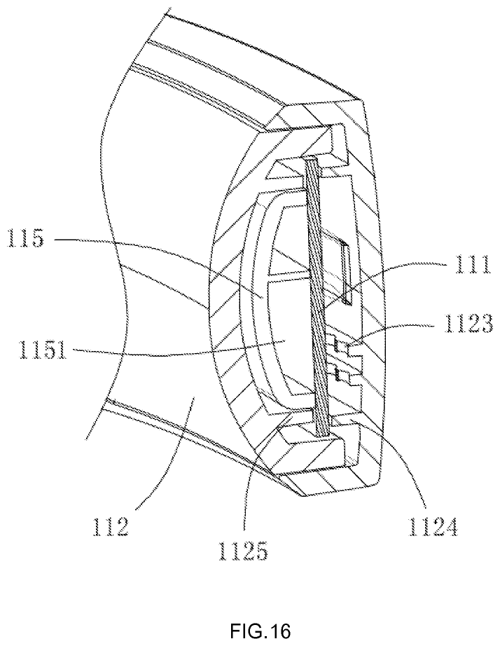

Preferably, referring to FIG. 16, to stabilize a position of the arc-shaped headband 111 in the inserting channels 1121, at least one first limiting rib 1124 and at least one second limiting rib 1125 are provided on opposite inner walls of each of the inserting channels 1121 respectively. An insertion gap for inserting the arc-shaped headband 111 is formed between said at least one first limiting rib 1124 and said at least one second limiting rib 1125 of each of the inserting channels 1121. Accordingly, said at least one first limiting rib 1124 and said at least one second limiting rib 1125 support the front and back surfaces of the arc-shaped headband 111, as shown in FIG. 16, such that the arc-shaped headband 111 can be prevented from lateral displacement, thereby preventing the elastic positioning members 117 from disengaging from the corresponding limiting guide portions 1122. To facilitate manufacturing of the connecting handles 112, each of the connecting handles 112 is formed by a plurality of housings, which may be separately made by injection molding and then assembled together to form the corresponding connecting handle 112.

The foregoing shows only preferred embodiments of the present invention and is not intended to limit the present invention. Any modification, alternative configurations, and improvements made without departing from the essence and principle of the present invention shall fall within the protection scope of the present invention.

What is claimed is:

1. A speaker module for a headset, comprising a speaker housing; a speaker body, a first microphone, a second microphone, and a circuit board are mounted on the speaker housing; the first microphone and the second microphone are oriented in different directions on the speaker housing; the circuit board is electrically connected to the speaker body, the first microphone, and the second microphone; the circuit board is provided with a circuit board plug port, and the circuit board plug port is exposed from the speaker housing.

2. The speaker module of claim 1, wherein the speaker housing comprises a housing body and a housing cover; the speaker body is disposed between the housing body and the housing cover; the first microphone is disposed on the housing cover, and the second microphone and the circuit board are disposed on a back side of the housing body opposite to the housing cover.

3. The speaker module of claim 2, wherein a first mounting positioning groove is provided on the back side of the housing body; a wire passing hole is disposed in the first mounting positioning groove; the circuit board is embedded in the first mounting positioning groove, and the circuit board covers the wire passing hole.

4. The speaker module of claim 3, wherein an annular enclosing plate is provided on an inner side of the housing cover facing towards the housing body; the speaker body is mounted in a space enclosed by the annular enclosing plate; an outer side of the speaker body is hermetically connected to an inner side of the annular enclosing plate;
the housing cover is provided with at least one sound transmission hole located within an area enclosed by the annular enclosing plate;
a sealing gasket surrounding the annular enclosing plate is provided on the inner side of the housing cover; edges of the housing body are pressed against the sealing gasket.

5. The speaker module of claim 4, wherein a second mounting positioning groove is provided on the inner side of the housing cover; the second mounting positioning groove is located within the area enclosed by the annular enclosing plate; the first microphone is embedded in the second mounting positioning groove; a third mounting positioning groove is provided on the back side of the housing body, and the second microphone is embedded in the third mounting positioning groove.

6. The speaker module of claim 1, wherein a housing body plug port is disposed on the speaker housing; the housing body plug port is connected with an audio cable; the housing body plug port is electrically connected to the circuit board.

7. The speaker module of claim 4, wherein an air hole is disposed on the housing body; and an air permeable membrane is provided on the air hole.

8. The speaker module of claim 2, further comprising a pressing plate disposed outside the speaker housing.

9. The speaker module of claim 8, wherein the pressing plate is defined by peripheral portions of the housing cover outside a coverage area by the housing body.

10. The speaker module of claim 9, wherein an ethyl vinyl acetate (EVA) cushion is disposed on an outer side of the pressing plate.
